(19) United States
(12) Patent Application Publication
(10) Pub. No.: US 2018/0286182 A1
(43) Pub. Date: Oct. 4, 2018

(54) METHOD AND SYSTEM FOR ADMINISTERING A LOTTERY IN COMBINATION WITH A PARI-MUTUEL POOL

(71) Applicant: Equilottery LLC, Louisville, KY (US)

(72) Inventor: Bradford T. Cummings, Louisville, KY (US)

(21) Appl. No.: 15/922,559

(22) Filed: Mar. 15, 2018

Related U.S. Application Data
(60) Provisional application No. 62/479,736, filed on Mar. 31, 2017.

(51) Int. Cl. G07F 17/32; G06Q 50/34; G06F 7/58

(52) U.S. Cl. CPC G07F 17/3288; G06F 7/58; G06Q 50/34; G07F 17/3244

(57) ABSTRACT

In a method and system for administering a lottery in combination with a pari-mutuel pool, a ticket is generated at a point-of-purchase terminal that includes a series of numbers. A first portion of the purchase price of the ticket is allocated to the pari-mutuel pool for an event, and a wager is entered in the amount of the first portion of the purchase price in a pari-mutuel pool for the event. A second portion of the purchase price is allocated to a progressive pool. After occurrence of the event, a determination is made as to whether the series of numbers on the ticket matches a winning series of numbers determined by the event, and if so, a payout is made from the pari-mutuel pool. Furthermore, after occurrence of the event, a determination is made as to whether the player qualifies for a progressive payout from the progressive pool.

### CROSS-REFERENCE TO RELATED APPLICATIONS

The present application claims priority to U.S. Patent Application Ser. No. 62/479,736 filed on Mar. 31, 2017, the entire disclosure of which is incorporated herein by reference.

### BACKGROUND OF THE INVENTION

The present invention is a method and system for administering a lottery in combination with a pari-mutuel pool.

Lottery games are a common form of gambling in which the winners are determined in some random manner. For example, each player may purchase a ticket with a random sequence of numbers. If that random sequence of numbers, or a portion of that sequence, is selected in a subsequent random drawing or selection of numbers, the player wins a cash amount that may be fixed or may be determined as a percentage of the receipts from tickets for that particular drawing. For another example, instant lottery tickets provide a player the opportunity to win a cash amount (or another prize) without waiting for a subsequent drawing. Specifically, an instant lottery ticket generally includes winning (or losing) numbers or icons that are concealed on the ticket itself. The numbers or icons are typically hidden by a coating. By removing this coating, the player can instantly determine whether or not it is a winning ticket rather than waiting for a subsequent drawing.

Another common form of gambling is pari-mutuel wagering, which is commonly used in connection with horse racing. In pari-mutuel wagering, all wagers (or bets) are collected in a pool. The house take is removed from the pool, and the payoff odds are then calculated by sharing the pool among all winning wagers. Thus, in pari-mutuel wagering, the payout odds go up and down depending on the amount of money wagered on each horse or group of horses. This allows for certain combinations of numbers to pay out more as compared to others. That being said, handicapping a horse race is difficult and is considered a skill, as skilled players place wagers based on past performances of the horses entered. While this is appealing to a certain minority of the public, most people do not understand how to handicap and, therefore, do not become long-term participants in the gambling side of the horse industry.

U.S. Pat. No. 8,734,240, which is incorporated herein by reference, describes a method and system for administering a lottery in combination with a pari-mutuel pool that combines the mass appeal of a lottery with the unpredictable and oftentimes exciting payouts of a pari-mutuel wagering system.

As described in U.S. Pat. No. 8,734,240, in an exemplary implementation, multiple point-of-purchase terminals, similar to the point-of-purchase terminals that are currently used in lottery operations, are provided at various retail locations. Using such point-of-purchase terminals, a ticket can be purchased in the same manner that current lottery tickets are purchased. Each ticket includes a series of randomly generated numbers. For example, to the extent that the ticket would be tied to a trifecta wager on a horse race, each ticket would include three randomly selected numbers that correspond to the entrants in a particular horse race. For another example, to the extent that the ticket would be tied to a superfecta wager on a horse race, each ticket would include four randomly selected numbers that correspond to the entrants in a particular horse race. For yet another example, to the extent that the ticket would be tied to a Pick 6 wager on six separate horse races, each ticket would include six randomly selected numbers that correspond to the entrants in those six horse races.

Each of the point-of-purchase terminals is in communication with a first computer server and associated database to record the purchase of each ticket. That computer server is then in communication with a second computer server and associated database that manages a pari-mutuel pool, such as that associated with a horse race.

When a ticket is purchased, a portion of the purchase price is treated as a wager and allocated to a pari-mutuel pool. The first computer server communicates with the second computer server managing the pari-mutuel pool and records the wager. Another portion of the purchase price is then allocated into other pools, including a supplemental payout pool.

At some future date, there will be a horse race or similar event that will determine a winning series of numbers. If a player has a matching ticket, i.e., the series of randomly generated numbers on the ticket matches the winning series of numbers from the outcome of horse race or similar event, the player is a winner and is entitled to a payout. The preliminary amount of the payout is determined by the amount generated by the wager in the pari-mutuel pool. A determination is made as to whether this preliminary amount exceeds a predetermined minimum amount. If so, that preliminary amount is treated as the final payout and awarded to the player. If not, the pool that is used to supplement winning payouts is accessed to make up the difference, and the predetermined minimum amount is treated as the final payout and awarded to the player.

Although the exemplary implementation of the method and system described above makes use of a supplemental payout pool, it should be recognized and understood that, in some implementations, such a supplemental payout pool could be eliminated or modified.

As further described in U.S. Pat. No. 8,734,240, in certain alternative implementations of the method and system, it is contemplated that the player could choose the numbers rather than rely on a series of randomly generated numbers.

It would be desirable to improve upon the combination of a game of chance with a pari-mutuel pool (such as that associated with horse racing) as described in U.S. Pat. No. 8,734,240 to further increase the excitement of the game, but without unduly increasing the complexity of the game.

### SUMMARY OF THE INVENTION

The present invention is a method and system for administering a lottery in combination with a pari-mutuel pool. Such a method and system results in a game with more progressive payouts and greater excitement for the players. In other words, the method and system of the present invention combines the mass appeal of a lottery with the unpredictable and oftentimes exciting payouts of a pari-mutuel wagering system.

In an exemplary implementation of the method and system of the present invention, multiple point-of-purchase terminals are provided at various retail locations, including, for example, grocery stores, convenience marts, and gas stations. Using such point-of-purchase terminals, a ticket can be purchased in the same manner that current lottery tickets are purchased. Alternatively, such point-of-purchase terminals could be in the form of user devices, such as a smartphone, tablet, desktop computer, or other computing device.

Irrespective of what form of point-of-purchase terminal or user device is used by a particular player, a ticket is purchased that includes a series of randomly generated numbers or player-selected numbers. For example, to the extent that the ticket would be tied to a trifecta wager on a horse race, each ticket would include three numbers that correspond to the entrants in a particular horse race. For another example, to the extent that the ticket would be tied to a superfecta wager on a horse race, each ticket would include four numbers that correspond to the entrants in a particular horse race. For yet another example, to the extent that the ticket would be tied to a wager on multiple separate horse races, each ticket would include a multiple-digit series of numbers that corresponds to the entrants in those horse races.

Each of the point-of-purchase terminals and/or each of the user devices is in communication with a first computer server and associated database to record the purchase of each ticket. The first computer server is then in communication with another (or second) computer server and associated database that manages a pari-mutuel pool, such as that associated with a horse race.

When a ticket is purchased by a player, a first portion of the purchase price is allocated to the pari-mutuel pool for the event, with a wager entered in the amount of the first portion of the purchase price in the pari-mutuel pool for the event via communication between the first computer server and a second computer server managing the pari-mutuel pool for the event. Another portion of the purchase price is allocated to a progressive pool.

After the occurrence of the event, and using the first computer server, a determination is made as to whether the series of numbers on the ticket matches a winning series of numbers determined by the event, and if so, determining, using the first computer server, a preliminary amount of a payout from the wager in the pari-mutuel pool for the event via communication with the second computer server that manages the pari-mutuel pool. Furthermore, after occurrence of the event, and using the first computer server, a determination is made as to whether the player also qualifies for a progressive payout from the progressive pool.

In some implementations, another portion of the purchase price is also allocated to a supplemental payout pool. In such implementations, after the occurrence of the event, and using the first computer server, a determination is made as to whether the preliminary amount of the payout from the wager in the pari-mutuel pool exceeds a predetermined minimum amount, and if not, the supplemental payout pool is used to supplement the payout from the wager in the pari-mutuel pool, resulting in a final payout.

The method and system of the present invention thus combines a lottery with a pari-mutuel pool, resulting in a game with more progressive payouts and greater excitement for the players. In other words, the mass appeal of a lottery is combined with the unpredictable and oftentimes exciting payouts of a pari-mutuel wagering system. Furthermore, from the perspective of a typical lottery player, the money being supplied in the pari-mutuel pool by horseplayers may be seen as a bonus, while, from the perspective of a typical horse player, the additional “amateur” money in the pari-mutuel pool is also perceived as beneficial and increases the payouts when perceived favorites win.

### DESCRIPTION OF THE DRAWINGS

FIG. 1 is a schematic illustration of an exemplary implementation of the method and system of the present invention;

FIG. 2 is a diagram illustrating how the monies associated with the purchase of a ticket are allocated in an exemplary implementation of the method and system of the present invention;

FIG. 3 is a flow chart illustrating the determination of a payout for a ticket in which the monies have been allocated as in FIG. 2;

FIG. 4 is a diagram illustrating how the monies associated with the purchase of a ticket are allocated in another exemplary implementation of the method and system of the present invention;

FIG. 5 is a diagram illustrating how the monies associated with the purchase of a ticket are allocated in yet another exemplary implementation of the method and system of the present invention;

FIG. 6 is a flow chart illustrating the determination of a payout for a ticket in which the monies have been allocated as in FIG. 5; and

FIG. 7 is an illustration of the contributions to a progressive pool from multiple lottery administrators and/or casinos.

### DETAILED DESCRIPTION OF THE INVENTION

The present invention is a method and system for administering a lottery in combination with a pari-mutuel pool. Such a method and system results in a game with more progressive payouts and greater excitement for the players. In other words, the method and system of the present invention combines the mass appeal of a lottery with the unpredictable and oftentimes exciting payouts of a pari-mutuel wagering system.

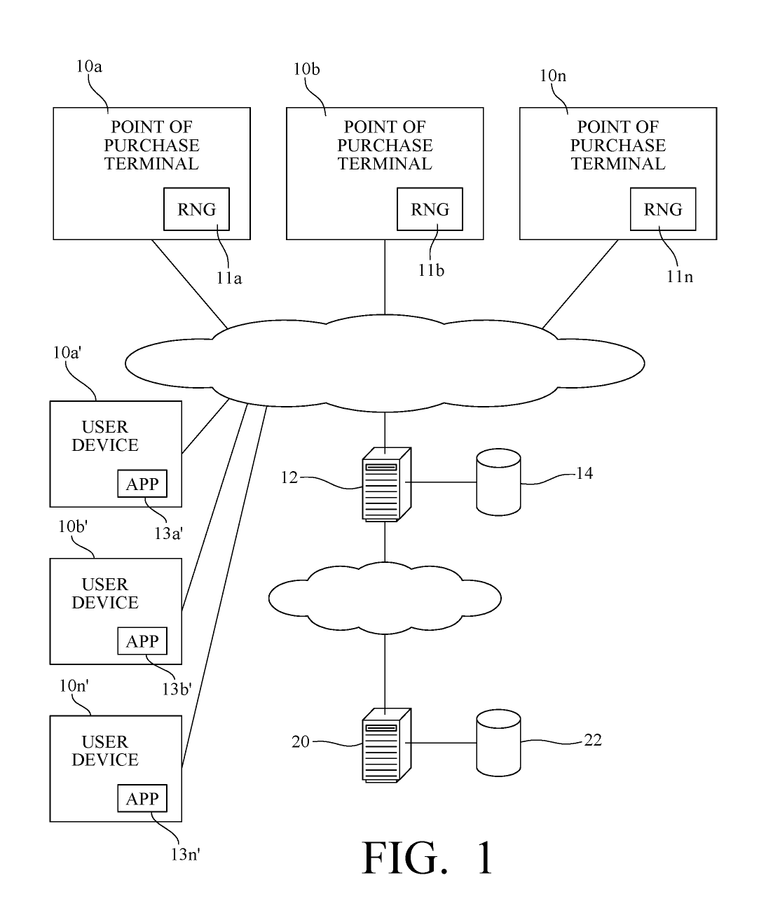

Referring now to FIG. 1, in an exemplary implementation of the method and system of the present invention, multiple point-of-purchase terminals 10a, 10b, . . . 10n are provided at various retail locations, including, for example, grocery stores, convenience marts, and gas stations. Similar to the point-of-purchase terminals that are currently used in lottery operations, each such point-of-purchase terminal 10a, 10b, . . . 10n generally comprises a computer with one or more input means, such as a keyboard, mouse, touch screen, etc. Using such point-of-purchase terminals 10a, 10b, . . . 10n, a ticket can be purchased in the same manner that current lottery tickets are purchased.

Alternatively, and as also illustrated in FIG. 1, such point-of-purchase terminals could be in the form of user devices 10a′, 10b′, . . . 10n′, such as a smartphone, tablet, desktop computer, or other computing device, each of which are running a software program 13a′, 13b′, . . . 13n′, preferably in the form of an application (or “app”). Each user device 10a′, 10b′, . . . 10n′ thus has a microprocessor, an internal memory component (e.g., a hard drive or solid-state drive), and a display screen. Alternatively, the software program 13a′, 13b′, . . . 13n′ could be a web-based application accessible through a common Internet browser.

Irrespective of what form of point-of-purchase terminal 10a, 10b, . . . 10n or user device 10a′, 10b′, . . . 10n′ is used by a particular player, a ticket is purchased that includes a series of randomly generated numbers. In other words, each point-of-purchase terminal 10a, 10b, . . . 10n includes a software-implemented random number generator (“RNG”) 11a, 11b, . . . 11n that produces a series of randomly generated numbers for the ticket. Similarly, the software program 13a′, 13b′, . . . 13n′ running on the user devices 10a′, 10b′, . . . 10n′ would include a RNG. For example, to the extent that the ticket would be tied to a trifecta wager on a horse race (as further discussed below), each ticket would include three randomly selected numbers that correspond to the entrants in a particular horse race. For another example, to the extent that the ticket would be tied to a superfecta wager on a horse race (as further discussed below), each ticket would include four randomly selected numbers that correspond to the entrants in a particular horse race. For yet another example, to the extent that the ticket would be tied to a Pick 6 wager on six separate horse races (as further discussed below), each ticket would include six randomly selected numbers that correspond to the entrants in those six horse races. Of course, this could be extended and applied to any number of horse races or similar events, wherein a multiple-digit series of numbers is randomly generated and treated as a wager on multiple separate horse races or similar events.

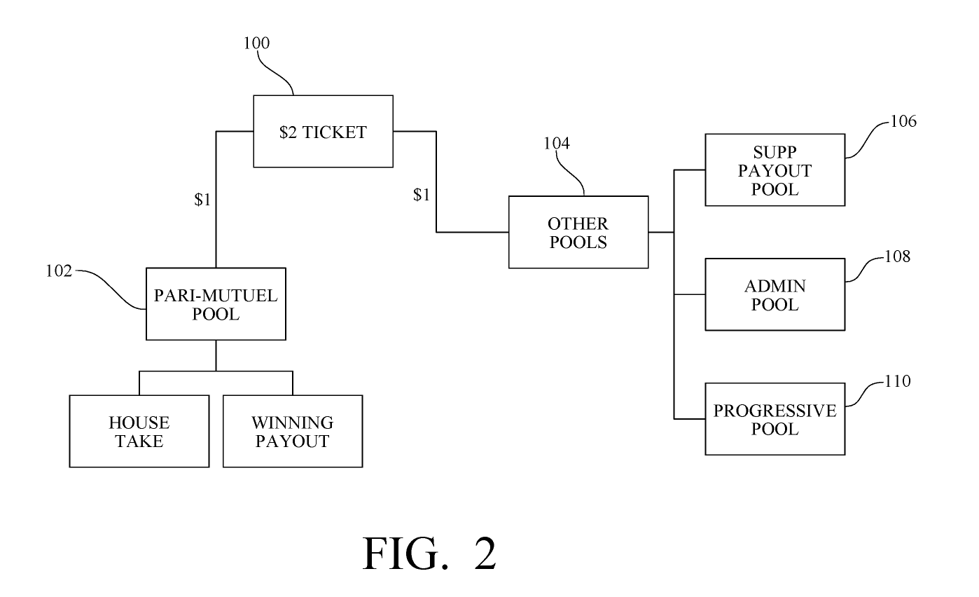

Referring still to FIG. 1, each of the point-of-purchase terminals 10a, 10b, . . . 10n and/or each of the user devices 10a′, 10b′, . . . 10n′ is in communication with a first computer server 12 and associated database 14 to record the purchase of each ticket. Such communications are preferably facilitated through an Internet connection, satellite communications, or similar known means of data transport. The first computer server 12 is then in communication with another (or second) computer server 20 and associated database 22 that manages a pari-mutuel pool, such as that associated with a horse race. Such communications are again preferably facilitated through an Internet connection, satellite communications, or similar known means of data transport. FIG. 2 is a diagram illustrating how the monies associated with the purchase of a ticket are allocated, which assists in explaining how the lottery function is combined with pari-mutuel wagering. In the example illustrated in FIG. 2, a $2 ticket is purchased, as indicated by block 100. As part of that purchase, the player identifies which horse race or horse races he is “wagering” on. One dollar ($1) of the purchase price is then treated as a wager and allocated to the pari-mutuel pool, as indicated by block 102. In this regard, the above-described random number generator (“RNG”) produces a series of randomly generated numbers for the ticket and wager. A three-digit series of numbers is randomly generated and treated as a trifecta wager on a particular horse race. A four-digit series of numbers is randomly generated and treated as a superfecta wager on a particular horse race. A six-digit series of numbers is randomly generated and treated as a Pick 6 wager on six separate horse races. Accordingly, the first computer server 12 communicates with the second computer server 20 managing the pari-mutuel pool (as illustrated in FIG. 1) and records the wager, such that a $1 wager is entered into the pari-mutuel pool. As with any pari-mutuel pool, and as described above, the house take (for profits, infrastructure, etc.) is removed from the pool, with the remaining funds used for winning payouts.

The second dollar ($1) of the purchase price is then allocated into other pools, as indicated by block 104. In this exemplary implementation, a first, supplemental payout pool 106 (SUPP PAYOUT POOL) is used to supplement winning payouts, as further described below. A second pool 108 (ADMIN POOL) is used for administrative expenses and/or other purposes, such as providing support to the horse racing industry in a particular location. Finally, unlike U.S. Pat. No. 8,734,240, a third pool 110 (PROGRESSIVE POOL) is established to provide an alternative source for winning payouts in certain circumstances, as further described below.

As an alternative, although not shown in FIG. 2, the player may be required to pay an additional amount to qualify for an award from the third pool 110 (PROGRESSIVE POOL). In other words, in such an alternative implementation, the player would have to pay an additional amount at the time of purchase of the ticket, which would be allocated to the third pool 110 (PROGRESSIVE POOL).

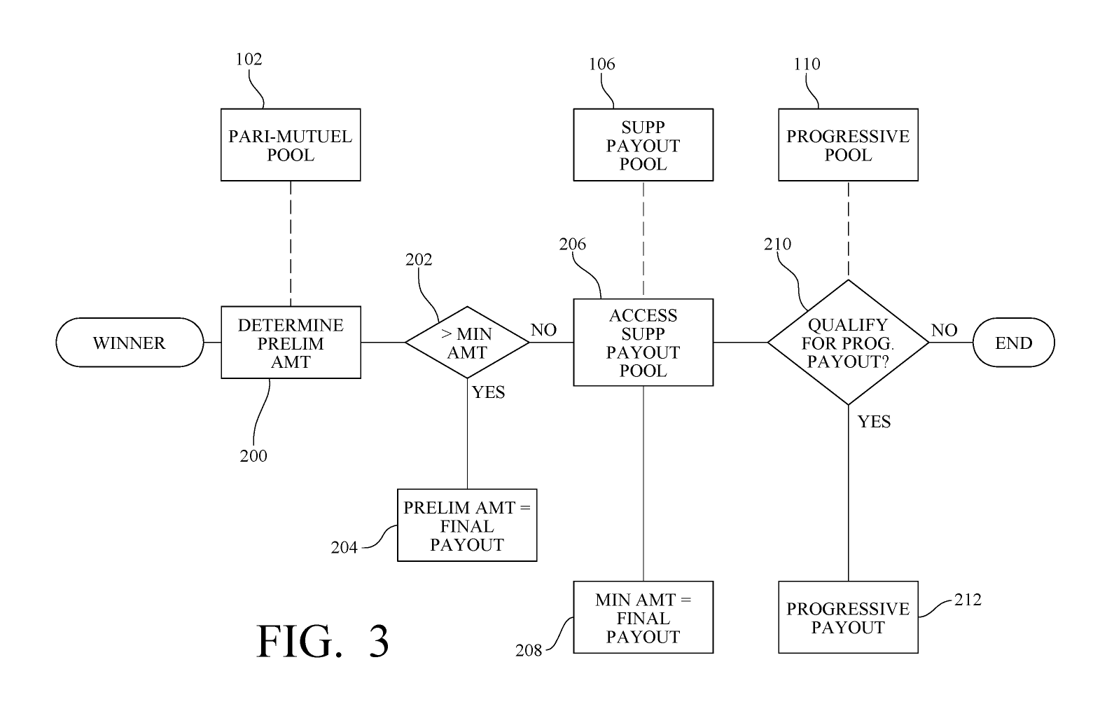

Referring now to FIG. 3, at some future date, there will be a horse race or similar event that will determine a winning series of numbers. In this regard, an “event” could also include multiple events, such as the six horse races that comprise a Pick 6 wager. If a player has a matching ticket, i.e., the series of randomly generated numbers on the ticket matches the winning series of numbers from the outcome of a horse race or similar event, the player is a winner and is entitled to a payout. The preliminary amount (PRELIM AMT) of the payout is determined by the amount generated by the $1 wager in the pari-mutuel pool, as indicated by block 200 of FIG. 3. In this regard, the amount generated by the $1 wager in the pari-mutuel pool is calculated by the second computer server 20 managing the pari-mutuel pool and communicated back to the first computer server 12. Then, a determination is made by the first computer server 12 at decision 202 as to whether this preliminary amount (PRELIM AMT) exceeds a predetermined minimum amount (MIN AMT). If so, that preliminary amount (PRELIM AMT) is treated as the final payout (FINAL PAYOUT) and awarded to the player, as indicated by block 204. If not, the supplemental payout pool 106 that is used to supplement winning payouts is accessed to make up the difference, as indicated by block 206, and the predetermined minimum amount (MIN AMT) is treated as the final payout and awarded to the player, as indicated by block 208.

With respect to the entry of a wager into the pari-mutuel pool as described above with reference to FIG. 2, this may be the same pool as used at the racetrack or may be a separate pool that is established as part of the method and system of the present invention.

Now, with respect to the third pool 110 (PROGRESSIVE POOL), this third pool 110 is intended to accumulate funds from across horse races or similar events. The funds in this third pool 110 are then accessed to make payouts in extraordinary circumstances.

For example, a player may have the opportunity to purchase a series of tickets for multiple selected horse races or similar events. If that player was a winner with respect to each individual horse race or similar event (as described above), the player would be entitled to the payout determined according to FIG. 3 above. Furthermore, for being a winner in all of the selected horse races or similar events, that player would also be entitled to progressive payout (i.e., an additional prize), which would be paid from the third pool 110.

For another example, a player may purchase a ticket with a series of numbers representing every horse in a particular horse race. The first three numbers may still be treated as a trifecta wager on the particular horse race, or the first four numbers may still be treated as a superfecta wager on the particular horse race. Furthermore, if the position of every horse in the particular horse race was correctly selected (or matched), that player would also be entitled to progressive payout (i.e., an additional prize), which would be paid from the third pool 110.

Thus, and as also shown in FIG. 3, a determination is also made by the first computer server 12 at decision 210 as to whether the winner also qualifies for a progressive payout, and if so, that progressive payout is also awarded to the player, as indicated by block 212.

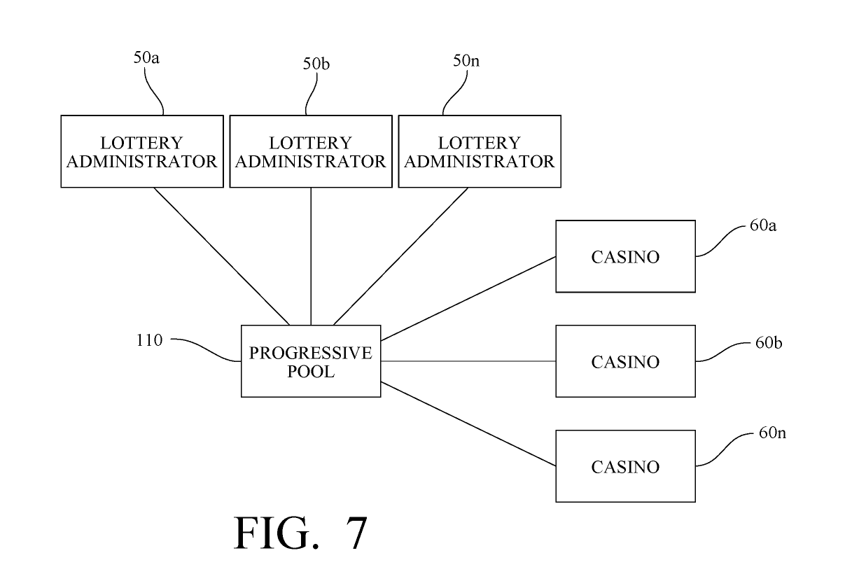

Furthermore, and referring now to FIG. 7, it is contemplated that the progressive pool 110 could be established across lottery administrators 50a, 50b, . . . 50n and/or casinos 60a, 60b, . . . 60n. Thus, while only a small portion of the purchase price for each ticket may be allocated to the progressive pool 110, with multiple lottery administrators 50a, 50b, . . . 50n or casinos 60a, 60b, . . . 60n contributing to the progressive pool 110, it can support larger payouts (or jackpots).

Thus, the method and system described above with reference to FIGS. 1-3 and FIG. 7 combines a lottery with a pari-mutuel pool, resulting in a game with more progressive payouts and greater excitement for the players. In other words, the mass appeal of a lottery is combined with the unpredictable and oftentimes exciting payouts of a pari-mutuel wagering system. Furthermore, from the perspective of a typical lottery player, the money being supplied in the pari-mutuel pool by horseplayers may be seen as a bonus, while, from the perspective of a typical horse player, the additional “amateur” money in the pari-mutuel pool is also perceived as beneficial and increases the payouts when perceived favorites win.

Lastly, although the exemplary implementation of the method and system described above with reference to FIGS. 1-3 makes use of a supplemental payout pool 106, it should be recognized and understood that, in some implementations, such a supplemental payout pool 106 could be eliminated or modified without departing from the spirit and scope of the present invention.

In an alternative implementation of the method and system of the present invention, it is contemplated that the player could choose the numbers rather than rely on a series of randomly generated numbers. If that option were to be offered, it is still contemplated that a portion of the purchase price would be allocated to the pari-mutuel pool for entering a wager in the pari-mutuel pool, while another portion of the purchase price would be allocated to a separate pool or pools, including a progressive pool.

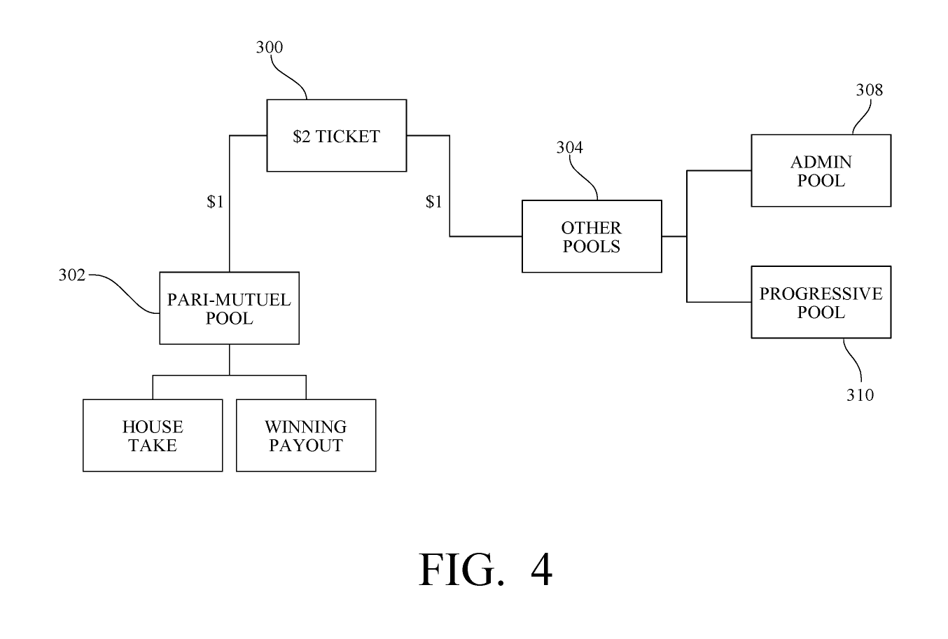

For example, and referring now to FIG. 4, a $2 ticket is purchased, as indicated by block 300. As part of that purchase, the player identifies which horse race or horse races he is “wagering” on and provides the user-selected numbers for input into the point-of-purchase terminal. For example, such user-selected numbers could be filled in on a “bubble” sheet as is commonly used in current lottery games and then scanned by the point-of-purchase terminal. For another example, such user-selected numbers could be input via a software program, such as an app running on a user device or a web-based application accessible through a common Internet browser (as described above with respect to FIG. 1). In this example, $1 of the purchase price is then treated as a wager and allocated to the pari-mutuel pool, as indicated by block 302. Accordingly, the first computer server 12 communicates with the second computer server 20 managing the pari-mutuel pool (as illustrated in FIG. 1), such that a $1 wager is entered into the pari-mutuel pool. Again, as with any pari-mutuel pool, and as described above, the house take (for profits, infrastructure, etc.) is removed from the pool, with the remaining funds used for winning payouts.

The remaining $1 of the purchase price is then allocated into other pools for administrative expenses and/or other purposes, including, for example, an administrative pool 308 (ADMIN POOL) that is used for administrative expenses and/or other purposes, and a progressive pool 310 (PROGRESSIVE POOL) is established to provide an alternative source for winning payouts in certain circumstances.

As an alternative, although not shown in FIG. 4, the player may be required to pay an additional amount to qualify for an award from the progressive pool 310 (PROGRESSIVE POOL). In other words, in such an alternative implementation, the player would have to pay an additional amount at the time of purchase of the ticket, which would be allocated to the progressive pool 310 (PROGRESSIVE POOL).

Thus, in this exemplary implementation, the payout would be determined solely by the amount generated by the wager in the pari-mutuel pool. There would be no pool to supplement winning payouts. However, there still would be a progressive pool 310 that could be accessed to make payouts in extraordinary circumstances.

In yet an alternative implementation of the method and system of the present invention, it is contemplated that the players could again choose their own numbers, while a supplemental pool was still available to ensure minimum payouts and a progressive pool was still established to provide an alternative source for winning payouts in certain circumstances. In such a scenario, however, it is contemplated that the supplemental payout pool may provide a lesser payout as compared to the payout in the scenario when the numbers are randomly generated, so that it would not attract experienced handicappers trying to take advantage of the system, but it would still allow the casual lottery player the opportunity to play his own numbers.

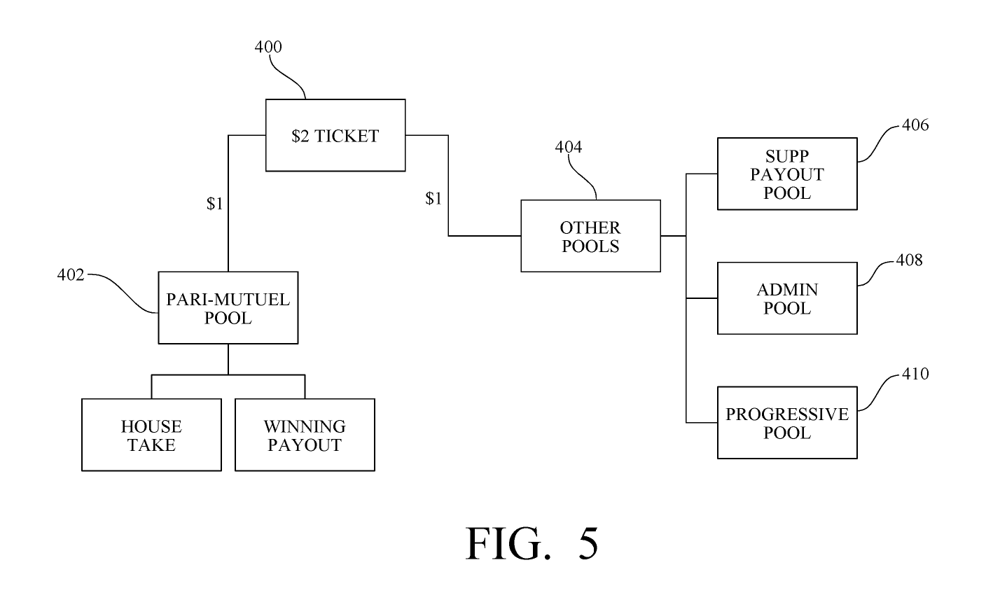

For example, and referring now to FIG. 5, a $2 ticket is purchased, as indicated by block 400. As part of that purchase, the player identifies which horse race or horse races he is “wagering” on and provides the user-selected numbers for input into the point-of-purchase terminal. In this example, $1 of the purchase price is then treated as a wager and allocated to the pari-mutuel pool, as indicated by block 402. Accordingly, the first computer server 12 communicates with the second computer server 20 managing the pari-mutuel pool (as illustrated in FIG. 1), such that a $1 wager is entered into the pari-mutuel pool. Again, as with any pari-mutuel pool, and as described above, the house take (for profits, infrastructure, etc.) is removed from the pool, with the remaining funds used for winning payouts.

The remaining $1 of the purchase price is then allocated into other pools, as indicated by block 404. Similar to the implementation described above with respect to FIGS. 2-3, a first, supplemental payout pool 406 (SUPP PAYOUT POOL) is used to supplement winning payouts, a second pool 408 (ADMIN POOL) is used for administrative expenses and/or other purposes, such as providing support to the horse racing industry in a particular location, and a third pool 410 (PROGRESSIVE POOL) is established to provide an alternative source for winning payouts in certain circumstances.

As an alternative, although not shown in FIG. 5, the player may be required to pay an additional amount to qualify for an award from the third pool 410 (PROGRESSIVE POOL). In other words, in such an alternative implementation, the player would have to pay an additional amount at the time of purchase of the ticket, which would be allocated to the third pool 410 (PROGRESSIVE POOL).

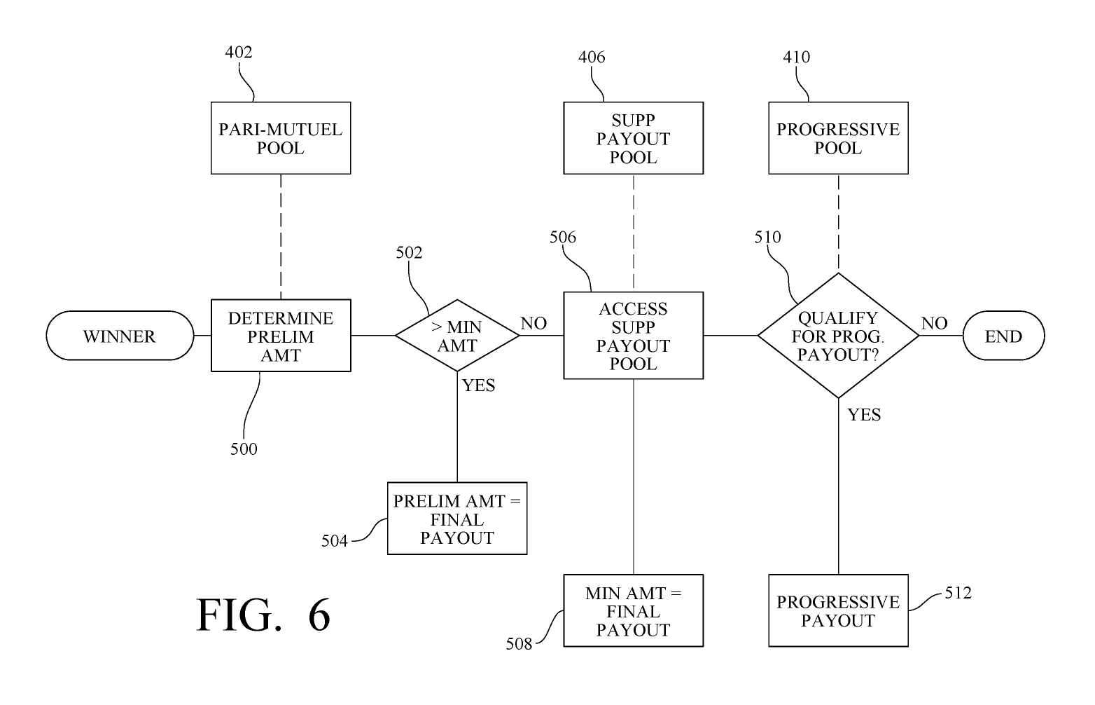

Referring now to FIG. 6, at some future date, there will be a horse race or similar event that will determine a winning series of numbers. If a player has a matching ticket, the player is a winner and is entitled to a payout. Similar to the implementation described above with respect to FIGS. 2-3, the preliminary amount (PRELIM AMT) of the payout is determined by the amount generated by the $1 wager in the pari-mutuel pool, as indicated by block 500 of FIG. 6. Then, a determination is made by the first computer server 12 at decision 502 as to whether this preliminary amount (PRELIM AMT) exceeds a predetermined minimum amount (MIN AMT). If so, that preliminary amount (PRELIM AMT) is treated as the final payout (FINAL PAYOUT) and awarded to the player, as indicated by block 504. If not, the supplemental payout pool 406 (FIG. 5) that is used to supplement winning payouts is accessed to make up the difference, as indicated by block 506, and the predetermined minimum amount (MIN AMT) is treated as the final payout and awarded to the player, as indicated by block 508. Finally, and as also shown in FIG. 6, a determination is also made by the first computer server 12 at decision 510 as to whether the winner also qualifies for a progressive payout, and if so, that progressive payout is also awarded to the player, as indicated by block 512.

One of ordinary skill in the art will recognize that additional implementations and/or embodiments are also possible without departing from the teachings of the present invention. This detailed description, and particularly the specific details of the exemplary implementations and embodiments disclosed therein, is given primarily for clarity of understanding, and no unnecessary limitations are to be understood therefrom, for modifications will become obvious to those skilled in the art upon reading this disclosure and may be made without departing from the spirit or scope of the present invention.

What is claimed is:

1. A method for administering a lottery in combination with a pari-mutuel pool for an event scheduled for a future date, comprising the steps of:
generating a ticket at a point-of-purchase terminal for a player that includes a series of randomly generated numbers and is acquired for a purchase price;
recording the generation of the ticket at a first computer server in communication with the point-of-purchase terminal;
allocating a first portion of the purchase price to the pari-mutuel pool for the event and entering a wager in the amount of the first portion of the purchase price in the pari-mutuel pool for the event via communication between the first computer server and a second computer server managing the pari-mutuel pool for the event;
allocating a second portion of the purchase price to a supplemental payout pool;
allocating a third portion of the purchase price to a progressive pool;
determining, after occurrence of the event, and using the first computer server, whether the series of randomly generated numbers on the ticket matches a winning series of numbers determined by the event, and if so, determining, using the first computer server, a preliminary amount of a payout from the wager in the pari-mutuel pool for the event via communication with the second computer server that manages the pari-mutuel pool;
determining, after occurrence of the event, and using the first computer server, whether the preliminary amount of the payout from the wager in the pari-mutuel pool exceeds a predetermined minimum amount, and if not, using the supplemental payout pool to supplement the payout from the wager in the pari-mutuel pool, resulting in a final payout; and
determining, after occurrence of the event, and using the first computer server, whether the player also qualifies for a progressive payout from the progressive pool.

2. The method as recited in claim 1, wherein the point-of-purchase terminal includes a software-implemented random number generator that generates the series of randomly generated numbers for the ticket.

3. The method as recited in claim 1, wherein the point-of-purchase terminal is a user device.

4. The method as recited in claim 3, wherein the user device is a smartphone, a tablet, a desktop computer, or another computing device.

5. A method for administering a lottery in combination with a pari-mutuel pool for one or more horse races scheduled for a future date, comprising the steps of:
generating a ticket at a point-of-purchase terminal for a player that includes a series of randomly generated numbers that correspond to entrants in the one or more horse races and is acquired for a purchase price;
recording the generation of the ticket at a first computer server in communication with the point-of-purchase terminal;
allocating a first portion of the purchase price to the pari-mutuel pool for the one or more horse races and entering a wager in the amount of the first portion of the purchase price in the pari-mutuel pool via communication between the first computer server and a second computer server managing the pari-mutuel pool;
allocating a second portion of the purchase price to a supplemental payout pool;
allocating a third portion of the purchase price to a progressive pool;
determining, after occurrence of the one or more horse races, and using the first computer server, whether the series of randomly generated numbers on the ticket matches a winning series of numbers determined by the one or more horse races, and if so, determining, using the first computer server, a preliminary amount of a payout from the wager in the pari-mutuel pool for the one or more horse races via communication with the second computer server that manages the pari-mutuel pool;
determining, using the first computer server, whether the preliminary amount of the payout from the wager in the pari-mutuel pool exceeds a predetermined minimum amount, and if not, using the supplemental payout pool to supplement the payout from the wager in the pari-mutuel pool, resulting in a final payout; and
determining, after occurrence of the one or more horse races, and using the first computer server, whether the player also qualifies for a progressive payout from the progressive pool.

6. The method as recited in claim 5, wherein the point-of-purchase terminal includes a software-implemented random number generator that generates the series of randomly generated numbers for the ticket.

7. The method as recited in claim 5, wherein the point-of-purchase terminal is a user device.

8. The method as recited in claim 7, wherein the user device is a smartphone, a tablet, a desktop computer, or another computing device.

9. The method as recited in claim 5, in which a three-digit series of numbers is randomly generated and treated as a trifecta wager on one horse race.

10. The method as recited in claim 5, in which a four-digit series of numbers is randomly generated and treated as a superfecta wager on one horse race.

11. The method as recited in claim 5, in which a multiple-digit series of numbers is randomly generated and treated as a wager on multiple separate horse races.

12. A method for administering a lottery in combination with a pari-mutuel pool for an event scheduled for a future date, comprising the steps of:
generating a ticket at a point-of-purchase terminal for a player that includes a series of player-selected numbers and is acquired for a purchase price;
recording the generation of the ticket at a first computer server in communication with the point-of-purchase terminal;
allocating a first portion of the purchase price to the pari-mutuel pool for the event and entering a wager in the amount of the first portion of the purchase price in the pari-mutuel pool for the event via communication between the first computer server and a second computer server managing the pari-mutuel pool for the event;
allocating a second portion of the purchase price to a progressive pool; and
determining, after occurrence of the event, and using the first computer server, whether the series of player-selected numbers on the ticket matches a winning series of numbers determined by the event, and if so, making a payout from the wager in the pari-mutuel pool; and
determining, after occurrence of the event, and using the first computer server, whether the player also qualifies for a progressive payout from the progressive pool.

13. The method as recited in claim 12, wherein the series of player-selected numbers correspond to entrants in one or more horse races.

14. The method as recited in claim 13, in which the series of player-selected numbers includes three numbers and is treated as a trifecta wager on one horse race.

15. The method as recited in claim 13, in which the series of player-selected numbers includes four numbers and is treated as a superfecta wager on one horse race.

16. The method as recited in claim 13, in which the series of player-selected numbers includes multiple numbers and is treated as a wager on multiple separate horse races.

17. A method for administering a lottery in combination with a pari-mutuel pool for an event selected scheduled for a future date, comprising the steps of:
generating a ticket at a point-of-purchase terminal for a player that includes a series of player-selected numbers and is acquired for a purchase price;
recording the generation of the ticket at a first computer server in communication with the point-of-purchase terminal;
allocating a first portion of the purchase price to the pari-mutuel pool for the event and entering a wager in the amount of the first portion of the purchase price in the pari-mutuel pool for the event via communication between the first computer server and a second computer server managing the pari-mutuel pool for the event;
allocating a second portion of the purchase price to a supplemental payout pool;
allocating a third portion of the purchase price to a progressive pool; and
determining, after occurrence of the event, and using the first computer server, whether the series of player-selected numbers on the ticket matches a winning series of numbers determined by the event, and if so, determining, using the first computer server, a preliminary amount of a payout from the wager in the pari-mutuel pool for the event via communication with the second computer server that manages the pari-mutuel pool;
determining, using the first computer server, whether the preliminary amount of the payout from the wager in the pari-mutuel pool exceeds a predetermined minimum amount, and if not, using the supplemental payout pool to supplement the payout from the wager in the pari-mutuel pool, resulting in a final payout; and
determining, after occurrence of the event, and using the first computer server, whether the player also qualifies for a progressive payout from the progressive pool.

18. The method as recited in claim 17, wherein the series of player-selected numbers corresponds to entrants in one or more horse races.

19. The method as recited in claim 18, in which the series of player-selected numbers includes three numbers and is treated as a trifecta wager on one horse race.

20. The method as recited in claim 18, in which the series of player-selected numbers includes four numbers and is treated as a superfecta wager on one horse race.

21. The method as recited in claim 18, in which the series of player-selected numbers includes multiple numbers and is treated as a wager on multiple separate horse races.

22. A system for administering a lottery in combination with a pari-mutuel pool for an event scheduled for a future date, comprising:
multiple point-of-purchase terminals, each such point-of-purchase terminal for generating tickets, each ticket for a player including a series of randomly generated numbers and being acquired for a purchase price;
a first computer server in communication with the multiple point-of-purchase terminals for recording the generation of each ticket, said first computer server allocating a first portion of the purchase price of each ticket to the pari-mutuel pool for the event, and said first computer server allocating a second portion of the purchase price to a progressive pool; and
a second computer server for managing the pari-mutuel pool for the event, said second computer server in communication with the first computer server, and said second computer server receiving and recording a wager in the amount of the first portion of the purchase price in the pari-mutuel pool associated with each ticket;
wherein, upon an occurrence of the event, said first computer server (i) determines whether the series of randomly generated numbers on each ticket matches a winning series of numbers determined by the event, and if so, determines an amount of a payout from the wager in the pari-mutuel pool for the event via communication with the second computer server that manages the pari-mutuel pool for the event, and (ii) determines whether the player also qualifies for a progressive payout from the progressive pool.

23. A system for administering a lottery in combination with a pari-mutuel pool for an event scheduled for a future date, comprising:
multiple point-of-purchase terminals, each such point-of-purchase terminal for generating tickets, each ticket for a player including a series of randomly generated numbers and being acquired for a purchase price;
a first computer server in communication with the multiple point-of-purchase terminals for recording the generation of each ticket, said first computer server allocating a first portion of the purchase price of each ticket to the pari-mutuel pool for the event, said first computer server allocating a second portion of the purchase price of each ticket to a supplemental payout pool, and said first computer server allocating a third portion of the purchase price to a progressive pool; and
a second computer server for managing the pari-mutuel pool for the event, said second computer server in communication with the first computer server, and said second computer server receiving and recording a wager in the amount of the first portion of the purchase price in the pari-mutuel pool associated with each ticket;
wherein, upon an occurrence of the event, said first computer server (i) determines whether the series of randomly generated numbers on each ticket matches a winning series of numbers determined by the event, and if so, determines a preliminary amount of a payout from the wager in the pari-mutuel pool for the event via communication with the second computer server that manages the pari-mutuel pool for the event, (ii) determines whether the preliminary amount of the payout from the wager in the pari-mutuel pool exceeds a predetermined minimum amount, and if not, uses the supplemental payout pool to supplement the payout from the wager in the pari-mutuel pool, resulting in a final payout, and (iii) determines whether the player also qualifies for a progressive payout from the progressive pool.

24. A system for administering a lottery in combination with a pari-mutuel pool for an event scheduled for a future date, comprising:
multiple point-of-purchase terminals, each such point-of-purchase terminal for generating tickets, each ticket for a player including a series of player-generated numbers and being acquired for a purchase price;
a first computer server in communication with the multiple point-of-purchase terminals for recording the generation of each ticket, said first computer server allocating a first portion of the purchase price of each ticket to the pari-mutuel pool for the event, and said first computer server allocating a second portion of the purchase price to a progressive pool; and
a second computer server for managing the pari-mutuel pool for the event, said second computer server in communication with the first computer server, and said second computer server receiving and recording a wager in the amount of the first portion of the purchase price in the pari-mutuel pool associated with each ticket;
wherein, upon an occurrence of the event, said first computer server (i) determines whether the series of player-generated numbers on each ticket matches a winning series of numbers determined by the event, and if so, determines an amount of a payout from the wager in the pari-mutuel pool for the event via communication with the second computer server that manages the pari-mutuel pool for the event, and (ii) determines whether the player also qualifies for a progressive payout from the progressive pool.

25. A system for administering a lottery in combination with a pari-mutuel pool for an event scheduled for a future date, comprising:
multiple point-of-purchase terminals, each such point-of-purchase terminal for generating tickets, each ticket for a player including a series of player-generated numbers and being acquired for a purchase price;
a first computer server in communication with the multiple point-of-purchase terminals for recording the generation of each ticket, said first computer server allocating a first portion of the purchase price of each ticket to the pari-mutuel pool for the event, said first computer server allocating a second portion of the purchase price of each ticket to a supplemental payout pool, and said first computer server allocating a third portion of the purchase price to a progressive pool; and
a second computer server for managing the pari-mutuel pool for the event, said second computer server in communication with the first computer server, and said second computer server receiving and recording a wager in the amount of the first portion of the purchase price in the pari-mutuel pool associated with each ticket;
wherein, upon an occurrence of the event, said first computer server (i) determines whether the series of player-generated numbers on each ticket matches a winning series of numbers determined by the event, and if so, determines a preliminary amount of a payout from the wager in the pari-mutuel pool for the event via communication with the second computer server that manages the pari-mutuel pool for the event, (ii) determines whether the preliminary amount of the payout from the wager in the pari-mutuel pool exceeds a predetermined minimum amount, and if not, uses the supplemental payout pool to supplement the payout from the wager in the pari-mutuel pool, resulting in a final payout, and (iii) determines whether the player also qualifies for a progressive payout from the progressive pool.
